(19) United States
(12) Patent Application Publication
(10) Pub. No.: US 2016/0167307 A1
(43) Pub. Date: Jun. 16, 2016

(54) SYSTEMS AND METHODS FOR 3D DIGITAL PRINTING

(71) Applicant: eBay Inc., San Jose, CA (US)

(72) Inventors: David Eramian, Mountain View, CA (US); Dane Glasgow, Los Altos, CA (US); David Ramadge, San Jose, CA (US); Corinne Elizabeth Sherman, San Jose, CA (US); Matthew Bret MacLaurin, Santa Cruz, CA (US)

(21) Appl. No.: 14/571,721

(22) Filed: Dec. 16, 2014

(51) Int. Cl. B29C 67/00; G05B 19/4099

(52) U.S. Cl. CPC B29C 67/0088; G05B 19/4099; B33Y 30/00

(57) ABSTRACT

Systems, methods, and media for three-dimensional (3D) printing are provided. In one example, a system comprises a data access module configured to receive data from a client device, the data including a two-dimensional image of a part; an identification module to identify the part based on the received data, or to receive an identification of the part included in the received data; a database storing a three-dimensional digital file of the identified part; a controller module, in communication with the database, to retrieve the three-dimensional digital file of the identified part from the database; and a transmission module to transmit the three-dimensional digital file to the client device, or to a 3D printer.

### TECHNICAL FIELD

The present application relates generally to the technical field of three-dimensional (3D) printing, and in one aspect to the identification and printing of spare parts depicted in two-dimensional images captured by users in the field, and in some further aspects to the analysis of such images to facilitate part failure analysis and improved design.

### BACKGROUND

Additive manufacturing or 3D printing is a process of making a three-dimensional solid object of virtually any shape from a digital model, 3D printing is achieved using an additive process, where successive layers of material are laid down in different shapes. 3D printing is considered distinct from traditional machining techniques, which mostly rely on the removal of material by methods such as cutting or drilling (subtractive processes).

The 3D printing technology is used for both prototyping and distributed manufacturing with applications in many fields of technology.

### BRIEF DESCRIPTION OF THE DRAWINGS

Some embodiments of the present disclosure are illustrated by way of example and not limitation in the figures of the accompanying drawings, in which like reference numbers indicate similar elements, and in which:

FIG. 1 is a schematic diagram of an online 3D printing environment for uploading 3D designs and specifications to a 3D printing services platform, in accordance with some embodiments;

FIG. 2 is a schematic diagram of 3D printing service channels in an online 3D printing environment, in accordance with some embodiments;

FIG. 3 is a network diagram depicting an example system for facilitating 3D printing services in an online environment, in accordance with some embodiments;

FIG. 4 is a block diagram showing components provided within a networked system, in accordance with some embodiments;

FIG. 5 is a block diagram of additional details of the example system of FIG. 4, in accordance with some embodiments;

FIG. 6 is a flowchart illustrating example method operations, in accordance with some embodiments; and

FIG. 7 is a diagrammatic representation of a machine in the example form of a computer system within which a set of instructions may be executed to cause the machine to perform any one or more of the methodologies discussed herein, in accordance with some embodiments.

### DETAILED DESCRIPTION

The description that follows includes illustrative systems, methods, techniques, instruction sequences, and computing machine program products that embody illustrative embodiments. In the following description, for purposes of explanation, numerous specific details are set forth in order to provide an understanding of various embodiments of the inventive subject matter. It will be evident, however, to those skilled in the art, that embodiments of the inventive subject matter may be practiced without these specific details. In general, well-known instruction instances, protocols, structures, and techniques have not been shown in detail. In this specification the terms “user” and “participant” are used interchangeably unless the context indicates otherwise.

In some embodiments, a service-provider system includes a communication module to communicate with a client device. A user operating the client device can take a two-dimensional photograph or video of a broken or non-functioning (failed) spare part and, using image recognition technology provided on the device or accessed remotely via a server, identify the part or the machine in which the part is used. In another example, the identification could be made by a service provider, instead of the user. In either case, based on the identification, a three-dimensional digital file for the spare part stored in a central database repository is accessed and the file is downloaded to the client device for 3D printing by the user. In another example, the digital file is downloaded directly to a local or remote 3D printer for automatic printing and delivery to (or pickup by) the user.

In further embodiments, the two-dimensional image or video of the broken spare part is uploaded to a remote device or server to facilitate part failure analysis. Failure data such as where and why the spare part failed are identified. The image or video analysis can be conducted manually by a failure analysis expert or team, or automatically by a failure analysis module. Other analysis examples include a combination of both manual and automatic analysis. An analysis module can identify certain features in the image, for example possible risers, cracks, deformities, anomalies, limits or extents of damage, zones of weakness, and other aspects, as examples. The automatic analysis may be conducted as part of an expanded failure analysis study which includes supplementary data not derived from the image or video analysis.

Based on the analysis, the three-dimensional digital file for the spare part is modified as appropriate to reduce the risk of further failure or improve aspects such as structural integrity or function, for example. Other aspects of modification are possible, such as temperature resistance, resistance to fatigue, or even merely a changed color, for example. 3D printing materials are selected or changed to optimize apart feature, function, or characteristic accordingly. The modified digital file is used for the subsequent 3D printing operations to create a modified spare part. An enhanced replacement part can thus be created.

In some examples, many thousands of parts, from many thousands of machines in the field, can be analyzed and auto-modified on failure to create improved replacement parts on a continuous basis. The systems and methods disclosed herein can be used as part of a preventative maintenance program, for example.

The process of modifying a spare part, or more specifically the file from which the spare part is 3D printed, may include an identification of primary and secondary functions or applications of the part. A replacement spare part can be created by 3D printing in such a way that a secondary use or application of the part is established in use even if the primary purpose or application of the part should fail again in use. That is, rather than just creating an identical piece for the part that failed, a replacement part is designed and created (modified) that will not only meet the needs of the original part, but in the event of a repeat failure will provide a secondary use or application. Establishing a secondary use or application of a spare part in use may include providing instructions to a user explaining on-site (in field) modification by the user of the part in the event of a repeat failure. Such modification may include a re-sizing or subdivision of a part, disassembly, or filing or trimming operations. The dimensions, clearances, and tolerance fits of original and replacement parts can be factored in to the design of a spare part modified for an auxiliary secondary use or application.

In some embodiments, control of digital rights in the digital file is managed and license payments to rights holders, where applicable, are automatically processed.

Thus, in some embodiments, a system comprises a processor-implemented data access module configured to receive data from a client device, the data including a two-dimensional image of a part; a processor-implemented identification module to identify the part based on the received data, or to receive an identification of the part included in the received data; a database storing a three-dimensional digital file of the identified part; a processor-implemented controller module, in communication with the database, to retrieve the three-dimensional digital file of the identified part from the database; and a processor-implemented transmission module to transmit the three-dimensional digital file to the client device, or to a 3D printer.

In some embodiments, the system further comprises a processor-implemented failure analysis module to analyze the data received from the client device, and automatically identify an aspect relating to a failure of the identified part.

In some embodiments, the system further comprises a processor-implemented part modification module configured to identify a modification to a design or function of the identified part based on the identified failure-related aspect and, in communication with the controller module, store a modified three-dimensional digital file of the identified part in the database, accordingly.

In some embodiments, the part modification module is further configured to identify a secondary use or application of the identified part, and incorporate the identified secondary use or application in a replacement part.

In some embodiments, the transmission module is further configured to communicate, in association with the three-dimensional digital file of the identified part, user instructions relating to the identified secondary use or application to the client device.

In some embodiments, the controller module is further configured to regulate an aspect of digital rights pertaining to the identified part, or to the three-dimensional digital file of the identified part.

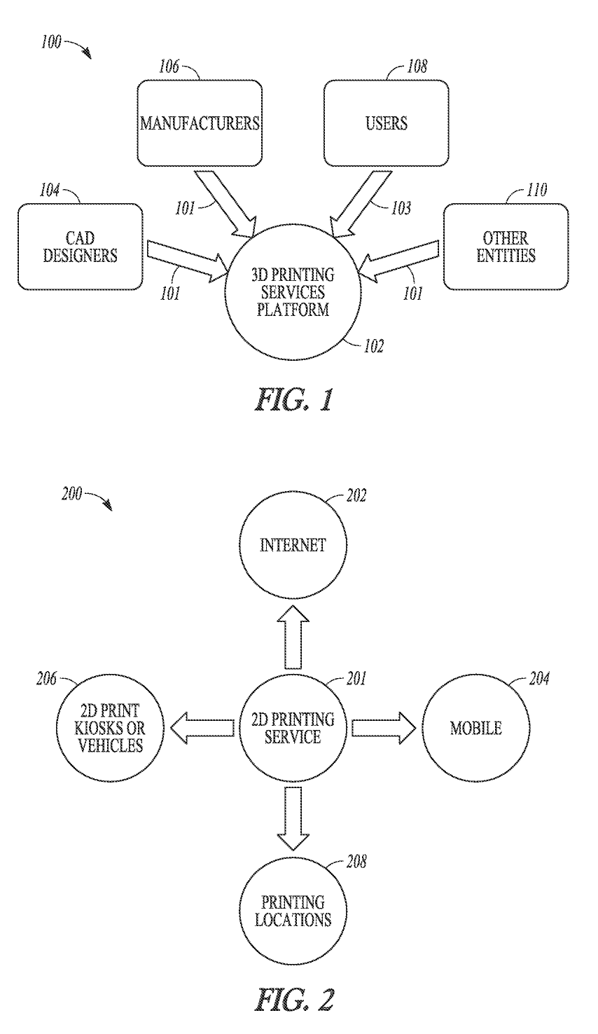

Referring now to FIG. 1. of the accompanying drawings, parts designers in an online 3D printing environment (generally designated by reference number 100) can, at operations 101, upload or make accessible spare part designs or specifications (including digital models, or three-dimensional digital files of the same) for 3D printing to a 3D printing services platform 102. The parts designers can include entities such as CAD designers 104 (e.g., engineering firms, architects), manufacturers (e.g., KITCHENAID™, WHIRLPOOL™) 106, or other entities 110 creating or owning 3D designs or digital models. The other entities 110 may include retailers, merchants, branded entities, TV channels, or online storefronts, for example. Other examples of marketplace participants are possible. In some examples, the CAD designers 104, manufacturers 106, and other entities 110 own rights to the digital models (three-dimensional digital files) submitted to the 3D printing services platform 102 and the printed 3D objects based on such models.

Users 108 have access to the 3D printing services platform 102 at operation 103. A user 108 may own or operate in the field a machine made by a manufacturer 106 and may desire a spare part for that machine. A replacement spare part for the machine can be made in accordance with the methods described in this specification.

With reference to FIG. 2, printing service channels in the online 3D printing environment 100 can include an online 3D printing service 201, interact channels 202, mobile channels 204, 3D print kiosks or vehicles 206, and 3D printing locations 208. The online 3D printing service 201, 3D print kiosks and vehicles 206, and/or printing locations 208 may be operated in whole or in part by any of the CAD designers 104, manufacturers 106, and other entities 110 shown in FIG. 1. In other examples, the 3D printing service 201 may be operated or hosted by an online marketplace provider such as AMAZON™ or ALIBABA™, for example. A user 108 can access the online 3D printing service 201 via an internet channel 202 or a mobile channel 204, for example.

In the event of a failure of a machine part, a user 108 seeking a replacement part can take a photograph or video of that part and send the two-dimensional image to the online 3D printing service 201. The online 3D printing service 201 includes or has access to a system having modules and functionality described further below which operate to provide the user 108 with a 3D printed replacement part, or a three-dimensional digital file from which the replacement part can be 3D printed.

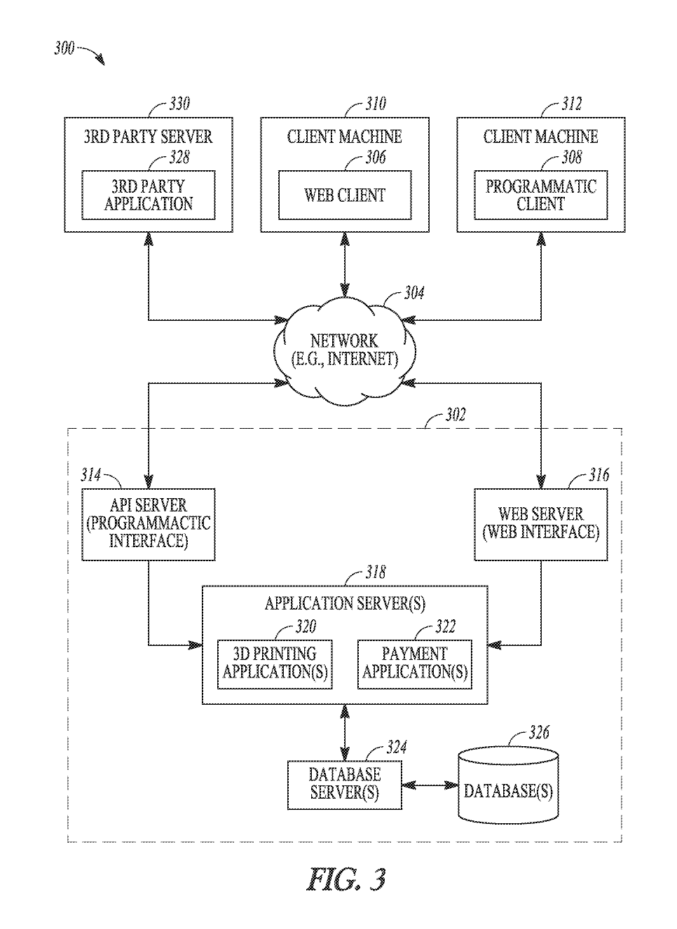

FIG. 3 is a network diagram depicting an example system 300 for facilitating 3D printing services in an online environment (e.g., the online 3D printing environment 100 of FIG. 1), according to some embodiments. A networked system 302 provides server-side functionality, via a network 304 (e.g., the Internet or a wide area network (WAN)), to one or more clients and devices (client devices). FIG. 3 further illustrates, for example, one or both of a web client 306 (e.g., a web browser) and a programmatic client 308 executing on client machines 310 and 312, respectively.

Each of the client machines 310 and 312 comprises a computing device that includes at least a display and communication capabilities with the network 304 to access the networked system 302. The client machines 310 and 312 comprise, but are not limited to, work stations, computers, general purpose computers, Internet appliances, hand-held devices, wireless devices, portable devices, wearable computers, cellular or mobile phones, portable digital assistants (PDAs), smart phones, tablets, ultrabooks, netbooks, laptops, desktops, multi-processor systems, microprocessor-based or programmable consumer electronics, game consoles, set-top boxes, network PCs, mini-computers, and the like. Each of the client machines 310 and 312 may connect with the network 304 via a wired or wireless connection. For example, one or more portions of the network 304 may be an ad hoc network, an intranet, an extranet, a virtual private network (VPN), a local area network (LAN), a wireless LAN (WLAN), a WAN, a wireless WAN (WWAN), a metropolitan area network (MAN), a portion of the Internet, a portion of the Public Switched Telephone Network (PSTN), a cellular telephone network, a wireless network, a WiFi network, a WiMax network, another type of network 304, or a combination of two or more such networks 304.

Each of the client machines 310 and 312 includes one or more applications (also referred to as “apps”) such as, but not limited to, a web browser, a messaging application, an electronic mail (email) application, an e-commerce site application, a 3D printing service application, and the like. In some embodiments, if the 3D printing service application is included in a given one of the client machines 310 and 312, then this application is configured to locally provide the user interface and at least some of the functionalities described herein, with the application configured to communicate with the networked system 302, on an as-needed basis, for data and/or processing capabilities not locally available (such as access to a database of digital models for sale, image recognition technology, 3D printing services available, authentication of a user, verification of a method of payment, etc.). Conversely, if the 3D printing application is not included in a given one of the client machines 310 and 312, the given one of the client machines 310 and 312 may use its web browser to access a suitably configured web portal (or a variant thereof) hosted on the networked system 302. Although two client machines 310 and 312 are shown in FIG. 3, more or fewer than two client machines can be included in the system 300.

An application program interface (API) server 314 and a web server 316 are coupled to, and provide programmatic and web interfaces respectively to, one or more application servers 318. The application server(s) 318 host one or more 3D printing applications 320 and payment applications 322. The application server(s) 318 are, in turn, shown to be coupled to one or more database servers 324 that facilitate access to one or more databases 326.

The 3D printing application(s) 320 may include or be associated with marketplace applications providing a number of e-commerce functions and services to users who access the networked system 302. E-commerce functions and services may include a number of publisher functions and services (e.g., search, listing, content viewing, payment, etc.). For example, the 3D printing application(s) 320 may provide a number of services and functions to users for listing parts and/or services or offers for parts and/or services for sale, searching for parts and services, facilitating transactions, and reviewing and providing feedback about transactions and associated users. The services can include 3D printing services. Additionally, the 3D printing application(s) 320 may track and store data and metadata relating to listings, transactions, 3D service providers, rankings, and user interactions. The data can include two-dimensional image data, digital model data (three-dimensional digital file data), digital rights data, digital rights certification and registration data, and digital model and 3D object verification data. In some embodiments, the 3D printing application(s) 320 publish or otherwise provide access to content items stored in the application server(s) 318 or the database(s) 326 accessible to the application server(s) 318 and/or the database server(s) 324. The payment application(s) 322 may likewise provide a number of payment services and functions to users.

While the 3D printing and payment applications 320 and 322 are shown in FIG. 3 to both form part of the networked system 302, it will be appreciated that, in alternative embodiments, the payment application(s) 322 may form part of a payment service that is separate and distinct from the networked system 302. In other embodiments, the payment application(s) 322 may be omitted from the system 300. In some embodiments, at least a portion of the 3D printing application(s) 320 or related functionality (e.g., image recognition technology) may be provided on the client machines 310 and/or 312.

Further, white the system 300 shown in FIG. 3 employs a client-server architecture, embodiments of the present disclosure are not limited to such an architecture, and may equally well find application in, for example, a distributed or peer-to-peer architecture system. The various 3D printing and payment applications 320 and 322 may also be implemented as standalone software programs, which do not necessarily have networking capabilities.

The web client 306 accesses the various 3D printing and payment applications 320 and 322 via the web interface supported by the web server 316. Similarly, the programmatic client 308 accesses the various services and functions provided by the 3D printing and payment applications 320 and 322 via the programmatic interface provided by the API server 314.

FIG. 3 also illustrates a third party application 328, executing on a third party server machine 330, as having programmatic access to the networked system 302 via the programmatic interface provided by the API server 314. For example, the third party application 328 may, utilizing information retrieved from the networked system 302, support one or more features or functions on a website hosted by a third party. The third party website may, for example, provide one or more promotional, marketplace, 3D printing service, or payment functions that are supported by the relevant applications of the networked system 302.

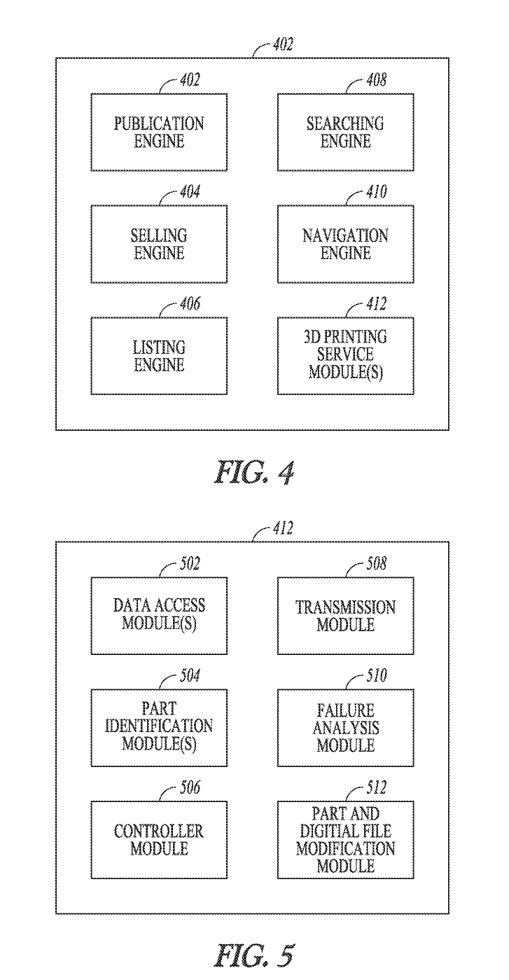

FIG. 4 is a block diagram showing components provided within the networked system 302, according to some embodiments. The networked system 302 may be hosted on dedicated or shared server machines not shown) that are communicatively coupled to enable communications between server machines. The components themselves are communicatively coupled (e.g., via appropriate interfaces) to each other and to various data sources, so as to allow information to be passed between the components or so as to allow the components to share and access common data. Furthermore, the components may access one or more databases 326 via the database server(s) 324.

The networked system 302 may provide a number of publishing, listing, and/or price-setting mechanisms whereby a design owner (e.g., CAD designer 104, manufacturer 106, or other entity 110 of FIG. 1) may list or publish information concerning parts (e.g., spare or replacement parts) or services (including 3D printing services, and related digital files for such parts) for sale or license. A user (e.g., user 108 of FIG. 1) can express interest in or indicate a desire to purchase such parts or services, and a transaction may be completed pertaining to the parts or services. To this end, the networked system 302 may comprise at least one publication engine 402 and one or more selling engines 404. The publication engine 402 may publish information, such as parts or service listings or product description pages, on the networked system 302.

A listing engine 406 allows design owners to conveniently author listings of spare parts and 3D printing services (e.g., 3D printing of replacement parts for WHIRLPOOL™ washing machines, or KITCHENAID™ dishwashers). In some embodiments, the listings may be an offer, deal, coupon, or discount for the part or service. The listing information may then be stored in one or more storage devices coupled to the networked system 302 (e.g., database(s) 326).

Searching the networked system 302 is facilitated by a searching engine 408. For example, the searching engine 408 enables keyword or part number queries of listings published via the networked system 302. In example embodiments, the searching engine 408 receives the keyword or part number queries from a client device (e.g., client machine 310 or 312 of FIG. 3) of a user 108 and conducts a review of the storage device storing the listing information. The review will enable compilation of a result set of listings that may be sorted and returned to the client device of the user 108. The searching engine 408 may record the query (e.g., keywords or part numbers) and any subsequent user actions and behaviors (e.g., navigations). The searching engine 408 also may perform a search based on a two-dimensional image of a part. The image may be taken from a camera or imaging component of a client device (e.g., client machine 310 or 312 of FIG. 3) or may be accessed from storage. In a further example, a navigation engine 410 allows users to navigate through various categories, catalogs, or inventory data structures according to which listings may be classified within the networked system 302.

In some embodiments, 3D printing service modules 412 are configured to create and implement the 3D printing service (e.g., the 3D printing services platform 102 of or the online 3D printing service 201 of FIG. 2) and other functions and methods described in this specification. It is contemplated that the 3D printing service modules 412 may be further configured to provide or perform any of the features, functions, methods, or operations related to 3D printing disclosed herein.

With reference to FIG. 5, the 3D printing service modules 412 include a data access module 502 configured to receive data from a client device (e.g., client machine 310 or 312 of FIG. 3). The received data includes a two-dimensional image (e.g., photograph or video footage) of a part that has failed in use and for which a replacement part is sought, for example by a user 108 of FIG. 1. The two-dimensional image of the part may have been captured by the user 108 operating a photo or video component of the client device, or otherwise downloaded to it.

The 3D printing service modules 412 also include a part identification module 504 to identify the part based on the received data, or to receive an identification of the part included in the received data. One or more of the 3D printing service modules 412 may be connected to a database (e.g., database 326 of FIG. 3) storing digital models (three-dimensional digital files) of parts, including the identified part. In this example, a processor-implemented controller module 506 is in communication with the database 326 to retrieve a three-dimensional digital file of the identified part from the database 326. A transmission module 508 transmits the retrieved three-dimensional digital file to the client device, or to a 3D printer.

In an enhanced version of a 3D printing service (e.g., the 3D printing services platform 102 of FIG. 1 or the online 3D printing service 201 of FIG. 2), the 3D printing service modules 412 further comprise a failure analysis module 510 to analyze the data received from the client device, and automatically identify an aspect relating to a failure of the identified part. A part modification module 512 is configured to identify a modification to a design or function of the identified part based on the identified failure-related aspect and, in communication with the controller module 506, store a modified three-dimensional digital file of the identified part in the database 326, accordingly.

in a further example, the part modification module 512 is further configured to identify a secondary use or application of the identified part, and incorporate the identified secondary use or application in a replacement part. In this situation, the transmission module 508 is further configured to communicate, in association with the modified three-dimensional digital file of the identified part, user instructions relating to the identified secondary use or application to the client device. The controller module 506 can be further configured to regulate aspects relating to digital rights management such as royalty payments, obtaining license rights, and certification of digital rights pertaining to the identified part or to the three-dimensional digital file from which the identified part is created.

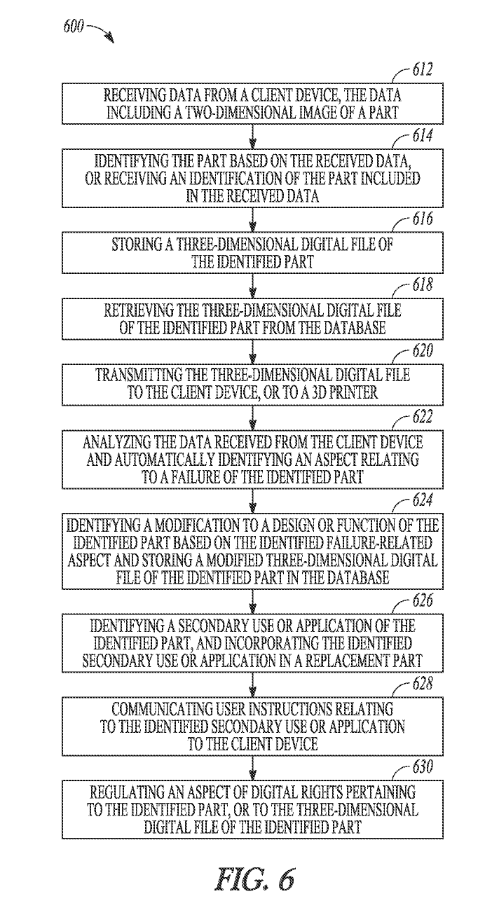

Some of the embodiments disclosed herein include methods. FIG. 6 is a flowchart illustrating a method 600 for 3D printing services. Some of the operations of the method 600 may be performed by the client machine 310, the client machine 312, and/or a server included in the networked system 302 (e.g., API server 314, web server 316, or application servers 318). The operations may be performed by one or more modules (e.g., 3D printing service modules 412). The various operations of the method 600 may be performed in different orders, and the method 600 may include only some of the operations described below.

The method 600 may comprise, at operation 612, receiving data from a client device, the data including a two-dimensional image of a part; at operation 614, identifying the part based on the received data, or receiving an identification of the part included in the received data; at operation 616, storing a three-dimensional digital file of the identified part; at operation 618, retrieving the three-dimensional digital file of the identified part from the database; and, at operation 620, transmitting the three-dimensional digital file to the client device, or to a 3D printer.

The method 600 may further comprise, at operation 622, analyzing the data received from the client device and automatically identifying an aspect relating to a failure of the identified part. Further, at operation 624, method 600 may include identifying a modification to a design or function of the identified part based on the identified failure-related aspect and storing a modified three-dimensional digital file of the identified part in the database, accordingly.

In some examples, method 600 further comprises, at operation 626, identifying a secondary use or application of the identified part, and incorporating the identified secondary use or application in a replacement part. At operation 628, method 600 may further comprise communicating user instructions relating to the identified secondary use or application to the client device. Still further, method 600 can include, at operation 630, regulating an aspect of digital rights pertaining to the identified part, or to the three-dimensional digital file of the identified part.

These and other variations in the performance of the method 600 are within the scope of embodiments of the present disclosure. The present disclosure also includes a non-transitory machine-readable medium including a set of instructions that, when executed by a machine, causes the machine to perform a set of operations described above.

Certain embodiments are described herein as including logic or a. number of components, modules, or mechanisms. Modules may constitute either software modules (e.g., code embodied on a machine-readable medium or in a transmission signal) or hardware modules. A hardware module is a tangible unit capable of performing certain operations and may be configured or arranged in a certain manner. In example embodiments, one or more computer systems (e.g., a standalone, client, or server computer system) or one or more hardware modules of a computer system (e.g., a processor or a group of processors) may be configured by software (e.g., an application or application portion) as a hardware module that operates to perform certain operations as described herein.

in various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time, For example, where the hardware modules comprise a general-purpose processor configured using software, the general-purpose processor may be configured as different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) among the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the network 304 of FIG. 3) and via one or more appropriate interfaces (e.g., APIs).

Example embodiments may be implemented in digital electronic circuitry, or in computer hardware, firmware, or software, or in combinations of these. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a standalone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output, Method operations can also be performed by, and apparatus of example embodiments may be implemented as, special purpose logic circuitry (e.g., an FPGA or an ASIC).

A computing system can include clients and servers. A client and server are generally remote from each other and typically interact through a communication network (e.g., network 304). The relationship of client and server arises by virtue of computer programs running on the respective computers and having a client-server relationship to each other. In embodiments deploying a programmable computing system, it will be appreciated that both hardware and software architectures merit consideration. Specifically, it will be appreciated that the choice of whether to implement certain functionality in permanently configured hardware (e.g., an ASIC), temporarily configured hardware (e.g., a combination of software and a programmable processor), or in a combination of permanently and temporarily configured hardware may be a design choice. Below are set out hardware (e.g., machine) and software architectures that may be deployed, in various example embodiments.

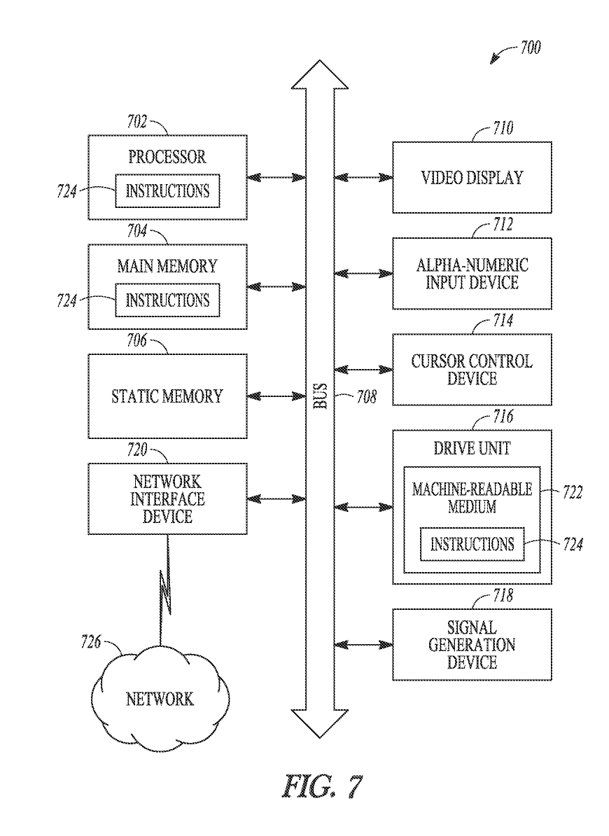

FIG. 7 is a block diagram of a machine in the example form of a computer system 700 within which instructions 724 for causing the machine to perform any one or more of the methodologies discussed herein may be executed. In alternative embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a personal digital assistant (PDA), cellular telephone, a web appliance, a network router, switch or bridge, or any machine capable of executing instructions 724 (sequential or otherwise) that specify actions to be taken by that machine. Further, while only a single machine is illustrated, the term “machine” shall also be taken to include any collection of machines that individually or jointly execute a set (or multiple sets) of instructions 724 to perform any one or more of the methodologies discussed herein.

The example computer system 700 includes a processor 702 (e.g., a central processing unit (CPU), a graphics processing unit (GPU), or both), a main memory 704, and a static memory 706, which communicate with each other via a bus 708. The computer system 700 may further include a video display 710 (e.g., a liquid crystal display (LCD) or a cathode ray tube (CRT)). The computer system 700 also includes an alphanumeric input device 712 (e.g., a keyboard), a user interface (UT) navigation (or cursor control) device 714 (e.g., a mouse), a disk drive unit 716, a signal generation device 718 (e.g., a speaker) and a network interface device 720.

The disk drive unit 716 includes a machine-readable medium 722 on which is stored one or more sets of data structures and instructions 724 (e.g., software) embodying or utilized by any one or more of the methodologies or functions described herein. The instructions 724 may also reside, completely or at least partially, within the main memory 704 and/or within the processor 702 during execution thereof by the computer system 700, the main memory 704 and the processor 702 also constituting machine-readable media 722. The instructions 724 may also reside, completely or at least partially, within the static memory 706.

While the machine-readable medium 722 is shown in an example embodiment to be a single medium, the term “machine-readable medium” may include a single medium or multiple media (e.g., a centralized or distributed database, and/or associated caches and servers) that store the one or more instructions 724 or data structures. The term “machine-readable medium” shall also be taken to include any tangible medium that is capable of storing, encoding, or carrying instructions 724 for execution by the machine and that cause the machine to perform any one or more of the methodologies of the present embodiments, or that is capable of storing, encoding, or carrying data structures utilized by or associated with such instructions 724. The term “machine-readable medium” shall accordingly be taken to include, but not be limited to, solid-state memories, and optical and magnetic media. Specific examples of machine-readable media 722 include non-volatile memory; including by way of example semiconductor memory devices (e.g., erasable programmable read-only memory (EPROM), electrically erasable programmable read-only memory (EEPROM), and flash memory devices); magnetic disks such as internal hard disks and removable disks; magneto-optical disks; and compact disc-read-only memory (CD-ROM) and digital versatile disc (or digital video disc) read-only memory (DVD-ROM) disks.

The instructions 724 may further be transmitted or received over a communications network 726 using a transmission medium. The instructions 724 may be transmitted using the network interface device 720 and any one of a number of well-known transfer protocols (e.g., HTTP). Examples of communication networks 726 include a LAN, a WAN, the Internet, mobile telephone networks, POTS networks, and wireless data networks (e.g., WiFi and WiMax networks). The term “transmission medium” shall be taken to include any intangible medium capable of storing, encoding, or carrying instructions 724 for execution by the machine, and includes digital or analog communications signals or other intangible media to facilitate communication of such instructions 724.

Although an embodiment has been described with reference to specific example embodiments, it will be evident that various modifications and changes may be made to these embodiments without departing from the broader spirit and scope of the present disclosure. Accordingly, the specification and drawings are to be regarded in an illustrative rather than a restrictive sense. The accompanying drawings that form a part hereof show, by way of illustration and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that wilt allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. A system comprising:
a processor-implemented data access module configured to receive data from a client device, the data including a two-dimensional image of a part;
a processor-implemented part identification module to identify the part based on the received data, or to receive an identification of the part included in the received data;
a database storing a three-dimensional digital file of the identified part;
a processor-implemented controller module, in communication with the database, to retrieve the three-dimensional digital file of the identified part from the database; and
a processor-implemented transmission module to transmit the three-dimensional digital file to the client device, or to a 3D printer.

2. The system of claim 1, further comprising:
a processor-implemented failure analysis module to analyze the data received from the client device, and automatically identify an aspect relating to a failure of the identified part.

3. The system of claim 2, further comprising:
a processor-implemented part modification module configured to identify a modification to a design or function of the identified part based. on the identified failure-related aspect and, in communication with the controller module, store a modified three-dimensional digital file of the identified part. in the database, accordingly.

4. The system of claim 3, wherein the part modification module is further configured to identify a secondary use or application of the identified part, and incorporate an element providing or allowing the identified secondary use or application in a replacement part.

5. The system of claim 4, wherein the transmission module is further configured to communicate, in association with the modified three-dimensional digital file of the identified part, user instructions relating to the identified secondary use or application to the client device.

6. The system of claim II, wherein the controller module is further configured to regulate an aspect of digital rights pertaining to the identified part, or to the three-dimensional digital file of the identified part.

7. A computer-implemented method comprising:
receiving data from a client device, the data including a two-dimensional image of a part;
identifying the part based on the received data, or receiving an identification of the part included in the received data;
storing a three-dimensional digital file of the identified part;
retrieving the three-dimensional digital file of the identified part from a database; and
transmitting the three-dimensional digital file to the client device, or to a 3D printer.

8. The computer-implemented method of claim 7, further comprising:
analyzing the data received from the client device and automatically identifying an aspect relating to a failure of the identified part.

9. The computer-implemented method of claim 8, further comprising:
identifying a modification to a design or function of the identified part based on the identified failure-related aspect and storing a modified three-dimensional digital file of the identified part in the database, accordingly.

10. The computer-implemented method of claim 7, further comprising identifying a secondary use or application of the identified part, and incorporating an element providing or allowing the identified secondary use or application in a replacement part.

11. The computer-implemented method of claim 10, further comprising communicating user instructions relating to the identified secondary use or application to the client device.

12. The computer-implemented method of claim 7, further comprising regulating an aspect of digital rights pertaining to the identified part, or to the three-dimensional digital file of the identified part.

13. A non-transitory machine-readable medium including a set of instructions that, when executed by a machine, causes the machine to perform a set of operations including:
receiving data from a client device, the data including a two-dimensional image of a part;
identifying the part based on the received data, or receiving an identification of the part included in the received data;
storing a three-dimensional digital file of the identified part;
retrieving the three-dimensional digital file of the identified part from a database; and
transmitting the three-dimensional digital file to the client device, or to a. 3D printer.

14. The medium of claim 13, wherein the operations further comprise analyzing the data received from the client device and automatically identifying an aspect relating to a failure of the identified part.

15. The medium of claim 14, wherein the operations further comprise identifying a modification to a design or function of the identified part based on the identified failure-related aspect and storing a modified three-dimensional digital file of the identified part in the database, accordingly.

16. The medium of claim 13, wherein the operations further comprise identifying a secondary use or application of the identified part, and incorporating an element providing or allowing the identified secondary use or application in a replacement part.

17. The medium of claim 16, wherein the operations further comprise communicating user instructions relating to the identified secondary use or application to the client device.

18. The medium of claim 13, wherein the operations further comprise regulating an aspect of digital rights pertaining to the identified part, or to the three-dimensional digital file of the identified part.
